(19) United States
(12) Patent Application Publication
(10) Pub. No.: US 2006/0057538 A1
(43) Pub. Date: Mar. 16, 2006

(54) Clear view dental explorer

(76) Inventor: Jacques Hoeffleur, Wales, WI (US)

Correspondence Address: JACQUES HOEFFLEUR, D.D.S., 225 N. WALES RD., WALES, WI, 53183, US

(21) Appl. No.: 10/942,189

(22) Filed: Sep. 14, 2004

(51) Int. Cl. A61C 3/00

(52) U.S. Cl. 433/72

(57) ABSTRACT

The Clear View Dental Explorer acts like a standard clinical dental explorer, to detect tooth-borne caries and other anomalies during an oral dental exam. However, in addition to this function, the Clear View Dental Explorer also originates an air nozzle that blows saliva, blood, or plaque away from the area of clinical observation by directing a forceful stream of air to the tip, or pointed end, of the explorer instrument area.

The Clear View Dental Explorer acts similarly to a “standard dental explorer” when used in a dental oral examination. It has a handle and a pointed probe end that is used for detecting soft carious areas within tooth structure pits and fissures, on flat tooth surfaces and on convoluted tooth surfaces. Both the proprioceptive/tactile sensation as well as the clinical visualization aspects when using the dental explorer are important in caries diagnosis. The shape and structure of the explorer probe end is directly related to the tactile feedback received to the operator's hand and also influences the visual line of site to the examined area.

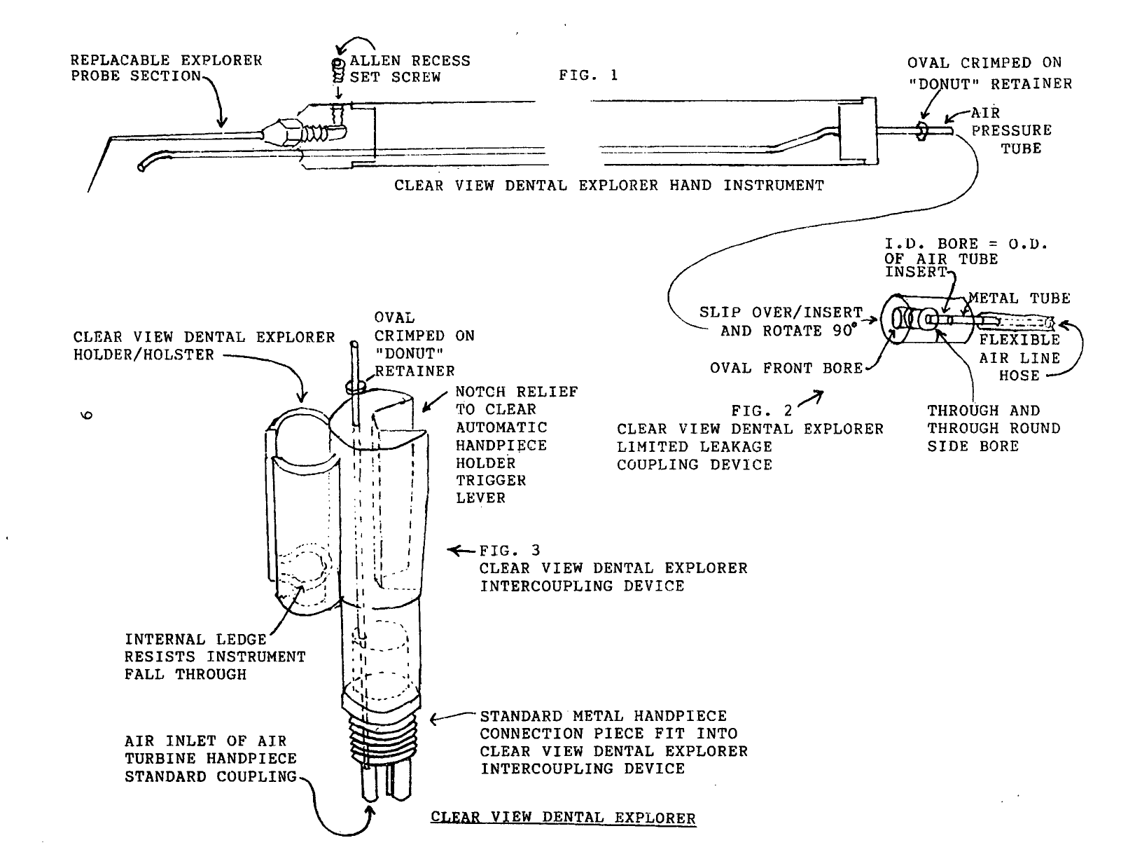

The Clear View Dental Explorer features, in addition to the “standard dental explorer,” an air tube that extends from the distal end of the handle, traverses through the handle, exits at the probe end of the explorer handle, and ultimately points its end-orifice at the probe's pointed tip (FIG. 1). Air can be actuated through this air tube, on demand, by the operator. During a dental oral examination, saliva, blood and plaque deposits are ubiquitously, to greater or lesser extent, covering interproximal tooth embrasure areas between teeth, are in tooth crevices, pits and fissures, and are pooled at the gingival to tooth margin areas. When an air blast is pressurized to the probe's pointed end, and subsequently the saliva, blood, or plaque is pushed away, the area of the examination results in an immediate and unobstructed view of the tooth surface. If a “standard dental explorer,” without the air tube feature is used, the operator has to put down either the mouth mirror or the standard explorer, then reach for the air/water syringe, give a blast of air to clear away the saliva/blood/plaque, then put the air/water syringe back in its holder, pick up the mirror or standard dental explorer quickly, and try to re-visualize the area before blood or saliva flows or wicks back into the area of examination. This is time consuming and often frustrating, especially when it has to be redundant in effort.

Air is conducted to the Clear View Dental Explorer by a flexible plastic hose line that has a quick disconnect fastener at both ends (FIG. 2). One end of the flexible tube connects to the distal end of the Clear View Dental Explorer handle and the other end of the flexible tube ultimately connects to the same hose coupling that is normally used to attach a standard air-powered turbine hand piece. This is accomplished by a unique inter-coupling device that is used to connect the flexible hose to the hand piece coupling (FIG. 3). The inter-coupling device also features an integral Clear View Dental Explorer mounting area. The inter-coupling device thus acts to both (1) connect the flexible air line to the standard hand piece tubing of the dental delivery unit, and (2) also acts as a mounting holster for the Clear View Dental Explorer. When all of the components are attached together, the inter-coupling device is stationed within the standard turbine hand piece holder and piggy-backs the Clear View Dental Explorer mounting holster. This mounting holster allows placement of the Clear View Dental Explorer in a non-cross-contamination area when not in use. Without the mounting holster, the instrument and its air hose would have to be draped on top of the other instruments on the instrument tray when not being used, which would obstruct removal of the other instruments on the tray, and would also allow the flexible air tube to touch and pick-up/transfer contaminants between the air tube and the other patient instruments on the tray. The quick disconnect fasteners at both ends of the flexible air line also allow easy disassembly of the Clear View Dental Explorer from the flexible air tubing for essential sterilization. Therefore, when the operator is using the Clear View Dental Explorer, actuation of the air blast is mediated by the standard delivery unit's foot control pedal, which provides a hands-free and variable control of air pressure spray to the examining area.

The Clear View Dental Explorer, in totality, is comprised of a system of three unique invention component units, which include:
a) The Clear View Dental Explorer Hand Instrument, noted in FIG. 1,
b) The Clear View Dental Explorer Limited Leakage Coupling Device, noted in FIG. 2, and
c) The Clear View Dental Explorer Intercoupling Device, noted in FIG. 3, and that each of these three invention components are connected together to comprise what is to be collectively called the Clear View Dental Explorer.

### SIMILAR INSTRUMENT COMPARISON AND DIFFERENCES

Reference: Thorup, Palle (20, Odensevej, 5750 Ringe, DK)
U.S. Pat. No. 4,048,723; Sep. 20, 1977
Dental Explorer
Filed: Sep. 15, 1975
Application # 613293

The prior art U.S. Pat. No. 4,048,723 lacks features similar to the Clear View Dental

Explorer:

(1) The air control of the prior art is not modulated by a hands-free foot control pedal. The prior art has a finger-actuated valve that is located on top of the instrument handle and at a position near the probe end of the handle. The foot control pedal feature of the Clear View Dental Explorer provides these advantages:
(a) It frees the operator from having to keep their fingers on the air valve lever/button.
(b) It allows for better instrument position manipulation in cases of rotating the instrument handle shaft position in the operator's hand and allows for placing the instrument in tightly-approximating areas and still have air modulation control without the task of maintaining finger to air-button positioning as would be necessary on the prior art.
(c) By not having the air regulating valve system in the handle position of the explorer instrument, the Clear View Dental Explorer becomes lighter in weight. This provides less hand fatigue over time and provides more propreoceptive/tactile feel to the dental operator.
(d) The prior art air modulating valve is located within the handle of the instrument. It consists of a spring, check ball and tapered valve seat. With frequent cycles of heat sterilization of these instruments, possible internal heat deterioration of the spring in the valve mechanism of the prior art, and possible corrosion and sediment accumulation, would indicate that an air modulator located outside of the instrument confines may improve upon the instrument's longevity.
(e) By not having the necessity of maintaining the operator's finger on the prior art's air valve/button, a better line of vision to the examining area is accomplished, as the presence of this finger may impair the operator's vision in some parameters.

(2) The Clear View Dental Explorer design features having the explorer probe as a separate component from the air jet blower tube. The prior art has both the probe and the air tube, that exist at the probe end of the instrument handle, joined as an integral and unified cast unit. Therefore, the prior art's probe system is thicker, stiffer, and greater in curvature dimension. By having the explorer probe section on the Clear View Dental Explorer being a separate component from the air jet blower tube, the following is accomplished:
(a) The thickness of the flexible probe portion of the Clear View Dental Explorer is substantially thinner than the analogous component of the prior art design. The Clear View Dental Explorer has a standard dimensional probe section thickness that emulates a standard, everyday variety of dental explorer. This is important in providing a standardized tactile/propreoceptive “feel” when using the explorer. The flexibility aspects of the probe section also regulate how much pressure can be applied to the explorer tip-point at the tooth surface when pressure is applied to the instrument by the operator.
(b) The prior art probe section is greater in dimensional curvature than on the Clear View Dental Explorer. The Clear View Dental Explorer therefore has a potentially better access ability in narrow areas between upper and lower posterior molars when examining the occlusal molar tooth surfaces.
(c) The standard sized (thinner) probe section of the Clear View Dental Explorer provides some improved and unobstructed visualization of the examining area.
(d) The standard sized (thinner) probe section of the Clear View Dental Explorer allows for a more accurate identification of softened carious tooth structure that resides within narrow pits and fissures that have caries deep within these convoluted tooth areas.

(3) The prior art differs from the Clear View Dental Explorer in that when replacement of the explorer probe section becomes necessary due to dulling of the pointed tip, the replacement of the explorer probe section for the prior art involves simultaneous replacement of both the probe section and the integral air tube section. Replacement only involves the probe section on the Clear View Dental Explorer and the air tube portion does not become part of the probe section replacement. In all explorers, the probe section tip/point eventually dulls after repeated normal use, making soft carious tooth structure less obvious to detect. Thus, explorers should regularly be replaced or refitted with new probe sections. Not having to replace the air tube section on the Clear View Dental Explorer will also potentially reduce the replacement cost.

(4) The prior art differs from the Clear View Dental Explorer in that the Clear View Dental Explorer uses the standard dental delivery unit hand piece hosing connector as an air source and therefore does not rely on any other air sources. And because the Clear View Dental Explorer uses the standard hand piece hose connection as its air source, this standard connection can also potentially be used for the addition of a fiber optic illumination light source cable/line to the Clear View Dental Explorer if future dental operators show a demand for it. The standard hand piece connected coupling often times has a fiber optic line as a standard feature for a light source when there is a fiber optic equipped hand piece involved.

(5) The prior art differs from the Clear View Dental Explorer in that the prior art does not incorporate provisions for an explorer mount/holster when the instrument is not in use. Therefore, in the case of the prior art, the operator would normally be obligated to set the prior art instrument and part of the accompanying flexible air line hose onto the patient's instrument tray during intermittent non-use periods of the prior art explorer. This would entail that part of the flexible air hose may end up touching some of the other instruments on the tray and, thus, the air line tube would become contaminated, or become a source of contamination to the other instruments on the tray. Another inconvenience of this scenario would be that the flexible air line, draped over the patient's tray, may obscure access to other instruments laying under the air line.

6) The prior art explorer design incorporates a barbed male connection end at the distal end of the handle for attachment of the flexible air line hose. This does not allow for easy and necessary disconnection of the air line hose from the explorer instrument. The Clear View Dental Explorer incorporates a quick disconnect fitting so that the flexible air line can be easily and routinely removed, so that the Clear View Dental Explorer hand instrument can be heat sterilized after every patient use.

7) The prior art differs from the Clear View Dental Explorer in that the probe section that is connected at the nose end of the instrument handle, and has the pointed tip, is a thicker cast metal piece on the prior art. The Clear View Dental Explorer fashions a probe section that is a wrought wire manufactured metal, which is identical to the manufacturing metal process of the probe section of a common/standard dental explorer instrument. This provides a more desirable probe thickness that is standard to common explorers and that can be more appropriately used for narrow pit and fissure depths of probing, provides a standard propreoceptive feel to the operator, and has less obscurity to the line of sight to the probe's pointed tip.

What is claimed is:

1) A dental explorer hand instrument, referred to as the Clear View Dental Explorer hand instrument, that also has an air tube nozzle for blowing away debris in the area of the oral examining site, and that this combination of an air tube nozzle and shank/probe with a pointed working end is different from the prior art, in that the Clear View Dental Explorer hand instrument has an air tube nozzle that is physically completely separate from the explorer shank (the shank being the wire-like segment of the hand instrument that extends between the working tip/end point and the anterior end of the instrument handle) and that this proposed inventive step of completely separating these components, the air tube and the shank, for the entire length so that each is separately attached to the instrument handle, allows the explorer shank on the Clear View Dental Explorer hand instrument to have the same design as found in current mainstream dental explorer hand instrument shanks, and whereby it is the design of the shank that contributes to the dental explorer hand instrument's handling/tactile feeling characteristics, and that by using this standard type of shank design on the Clear View Dental Explorer hand instrument, this, in turn, allows the Clear View Dental Explorer hand instrument to precisely match the deliverable and desirable utility handling and tactile characteristics of standard dental explorer hand instruments that do not have the air nozzle, and that these handling and tactile characteristics of the standard type of dental explorer hand instruments are directly related, in a large amount, to their shank design, which is, in general, for standard explorer shanks, a shank that is round and solid in its cross section and is tapered along its length to the pointed end, so as to have a controlled amount of flexing or spring mechanical property when pressure is applied to the pointed end, and also by using the standard mainstream explorer shank design, that would not be tubular in cross section, this allows less restriction to the shank's potential configuration in terms of allowing for sharp bends along the shank's long axis distance, and therefore allowing shank configurations that also match any standard explorer shank lineal shape/configuration along its long axis distance.

2) A device called the Clear View Dental Explorer Intercoupling Device that could be described, in part, as a coupling device, and that is used en route to indirectly connect the air source to the Clear View Dental Explorer hand instrument, as recited in claim #1, and acts by coupling one of the air tube segments of the multiple (three or four) fused tube standard delivery unit hand piece cabled hosing to a single tube which is a much thinner, more flexible, and more lightweight air line hose and that then this single tube hose would extend to the Clear View Dental Explorer hand instrument, and that this Clear View Dental Explorer Intercoupling Device has a proposed inventive step wherein it has incorporated into its shape a relief notch, so that as the Clear View Dental Explorer Intercoupling Device remains stationed in the standard hand piece holder/holster while the Clear View Dental Explorer hand instrument is being used or not being used, that the hand piece hose shut-off lever, located in the standard delivery unit hand piece holster, will not be triggered/activated.

3) The device, as recited in claim 2, wherein the Clear View Dental Explorer Intercoupling Device has incorporated into its shape a piggy-backed holding holster of its own for mounting and for maintenance of sterility of the Clear View Dental Explorer hand instrument when it is not being used.
